(19) United States
(12) Patent Application Publication
(10) Pub. No.: US 2019/0135447 A1
(43) Pub. Date: May 9, 2019

(54) ELECTRO-MECHANICAL ACTUATOR SYSTEM FOR OPENING AND CLOSING OF AIRCRAFT ENGINE COWL DOORS

(71) Applicant: Hamilton Sundstrand Corporation, Charlotte, NC (US)

(72) Inventor: Rajeev T. John, Bangalore (IN)

(21) Appl. No.: 15/866,252

(22) Filed: Jan. 9, 2018

(30) Foreign Application Priority Data
Nov. 7, 2017 (IN) 201711039631

(51) Int. Cl. B64D 29/06; B64D 29/08; F16H 25/20; F16H 25/22; F16H 25/24

(52) U.S. Cl. CPC B64D 29/06; B64D 29/08; F16H 2025/2065; F16H 25/2204; F16H 25/2454; F16H 25/2021

(57) ABSTRACT

A system for controlling the movement of an aircraft engine cowl door includes an actuator assembly having a housing and a screw shaft arranged at least partially within a hollow interior of the housing. The screw shaft is rotatable about an axis relative to the housing. A transmission system is coupled to the screw shaft to impart rotation to the screw shaft about the axis. A nut is engaged with the screw shaft and a piston rod having a rod end mounted thereto connects the nut to the cowl door of the engine. The nut is translatable relative to the screw shaft to transition the cowl door between a first position and a second position.

### CROSS-REFERENCE TO RELATED APPLICATIONS

This application claims the benefit of Indian Application Serial No. 201711039631 filed Nov. 7, 2017, which is incorporated herein by reference in its entirety.

### BACKGROUND

Embodiments of the present disclosure relate to a linear actuator and more specifically, to an electro-mechanical actuator used for opening and closing of the cowl doors of an aircraft engine.

Linear hydraulic actuators known as door opening system (DOS) actuators are normally employed to open aircraft engine cowl doors in order to gain access to the engine for maintenance operations. DOS actuators are currently hydraulically operated by drawing power from a ground support hand pump which supplies pressurized hydraulic oil. Current DOS actuators have multiple hydraulic components which require careful design and maintenance for durability and proper functioning. The current hydraulic actuators face many challenges like decreased performance at cold temperatures due to increase in oil viscosity, malfunctioning of the mechanical lock, hydraulic oil contamination, hydraulic oil spillage, oil leakage from pressure relief valves and seals etc. Hence there is a need for an improved cowl door opening system that is simple, reliable, cost effective, more “green” and light in weight.

### BRIEF DESCRIPTION

According to an embodiment, a system for controlling the movement of an aircraft engine cowl door includes an actuator assembly having a housing and a screw shaft arranged at least partially within a hollow interior of the housing. The screw shaft is rotatable about an axis relative to the housing. A transmission system is coupled to the screw shaft to impart rotation to the screw shaft about the axis. A nut is engaged with the screw shaft and a piston rod having a rod end mounted thereto connects the nut to the cowl door of the engine. The nut is translatable relative to the screw shaft to transition the cowl door between a first position and a second position.

In addition to one or more of the features described above, or as an alternative, in further embodiments the nut includes a key and an interior surface of the housing includes a key way within which the key is received.

In addition to one or more of the features described above, or as an alternative, in further embodiments comprising a first bracket mounted adjacent a first end of the housing and a second bracket mounted at an end of the piston rod, wherein the first bracket couples the actuator assembly to an engine casing and the second bracket couples the actuator assembly to the cowl door.

In addition to one or more of the features described above, or as an alternative, in further embodiments comprising a lost motion device coupled to the piston rod, the lost motion device being operable to absorb mechanical vibration of the cowl door and thermal expansion of the engine casing.

In addition to one or more of the features described above, or as an alternative, in further embodiments the transmission comprises a pair of bevel gears.

In addition to one or more of the features described above, or as an alternative, in further embodiments the transmission couples the screw shaft to a drive input including a torque limiter, wherein the torque limiter is configured to slip at an end of a stroke of the piston rod.

In addition to one or more of the features described above, or as an alternative, in further embodiments comprising a no-back device coupled to the screw shaft.

In addition to one or more of the features described above, or as an alternative, in further embodiments the actuator assembly is manually powered.

In addition to one or more of the features described above, or as an alternative, in further embodiments comprising a crank coupled to an input of the transmission.

In addition to one or more of the features described above, or as an alternative, in further embodiments the actuator system is electrically powered.

In addition to one or more of the features described above, or as an alternative, in further embodiments comprising an electric motor operably coupled to the actuator assembly via a flexible rotary shaft.

In addition to one or more of the features described above, or as an alternative, in further embodiments the electric motor receives power from a power supply.

In addition to one or more of the features described above, or as an alternative, in further embodiments comprising a speed reduction gear box coupled to the electric motor and a switch connected to an electrical power source which is capable of changing the polarity of the input to the electric motor such that the direction of rotation of the motor can be reversed.

In addition to one or more of the features described above, or as an alternative, in further embodiments movement of the cowl door between the first position and the second position provides access to the engine for maintenance.

According to another embodiment, a method of opening and closing the cowl doors of an aircraft engine includes providing an actuator assembly configured to translate a movable cowl, the actuator system including a screw shaft, and a nut engaged with the screw shaft, and a transmission operably coupled to the screw shaft. The method further includes providing a torque to a drive input of the actuator assembly, the drive input being in communication with the transmission, and rotating the screw shaft in a first direction such that the nut coupled to the screw shaft moves relative to the screw shaft, thereby causing the movable cowl to translate from a first position to a second position.

In addition to one or more of the features described above, or as an alternative, in further embodiments comprising rotating the screw shaft in a second, opposite direction such that the nut coupled to the screw shaft moves relative to the screw shaft, thereby causing the movable cowl door to translate from the second position to the first position.

In addition to one or more of the features described above, or as an alternative, in further embodiments providing torque to the drive input includes transmitting torque from an electric motor to the drive input via a flexible rotary shaft.

In addition to one or more of the features described above, or as an alternative, in further embodiments providing torque to the drive input includes manually supplying a torque to the drive input.

In addition to one or more of the features described above, or as an alternative, in further embodiments manually supplying the torque includes rotating a crank.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a side view of a typical aircraft engine including a nacelle assembly with cowl doors;

FIG. 2 is a schematic illustration of a front view of a typical aircraft engine showing the engine casing and the nacelle assembly and the cowl door actuators in the stowed and deployed conditions;

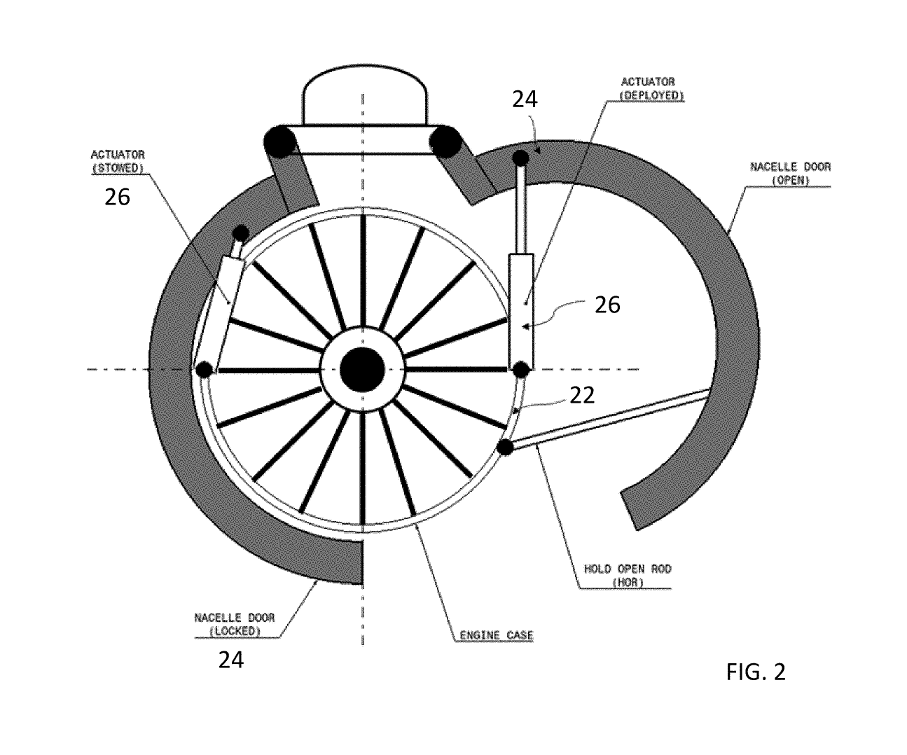

FIG. 3 is a schematic diagram of a door operating system according to an embodiment;

FIG. 4 is a cross-sectional view of an actuator assembly of the door operating system according to an embodiment; and

FIG. 5 is a cross-sectional view of the actuator assembly taken along cross section line A-A according to an embodiment.

### DETAILED DESCRIPTION

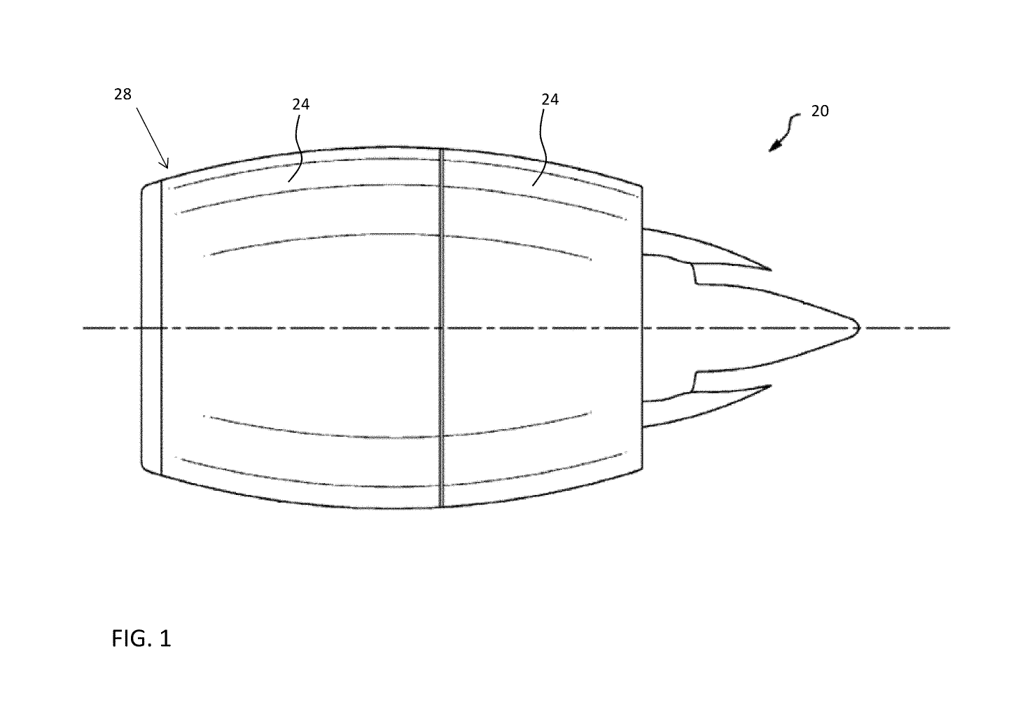

With reference to FIGS. 1 & 2 an aircraft engine assembly 20 is schematically illustrated which includes an engine casing 22, cowl doors 24 and cowl door opening actuators 26. The engine casing 22 houses engine components which are used to generate motive power for an aircraft. A nacelle structure 28 encloses the engine casing 22. Cowl doors 24 are part of the engine nacelle 28 and can be opened to gain access to the engine components for maintenance operations. The actuator 26 is interposed between engine casing 22 and cowl door 24. The concepts described herein shall be applied to various types of aircraft engines like turbo-fan engines, turbo-prop engines, turbo-jet engines, turbo-shaft engines, any future electric or hybrid engines which incorporate one or more engine cowl doors.

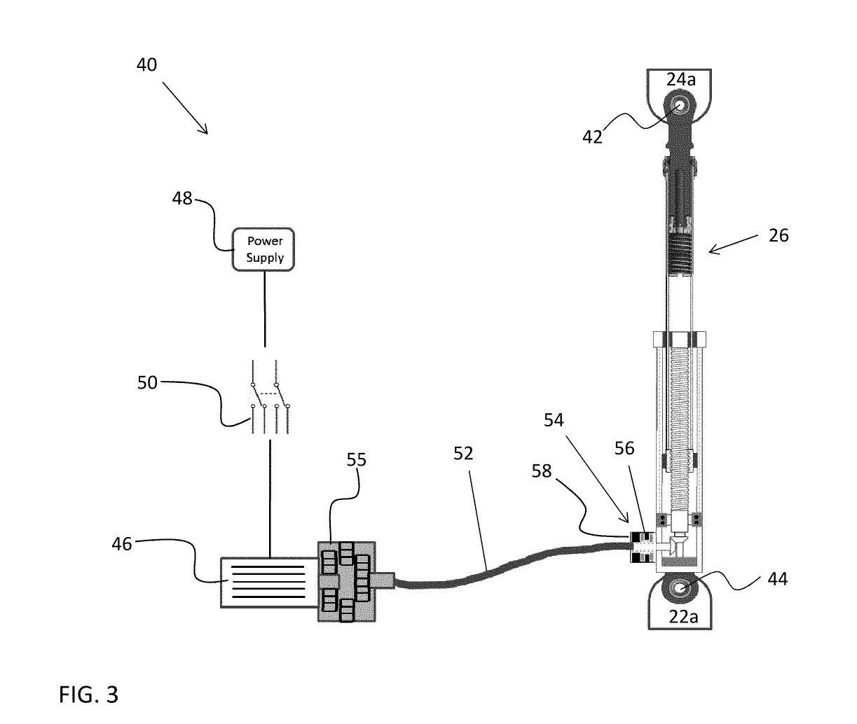

Referring to FIGS. 3-5, an embodiment of an aircraft engine cowl door opening system 40 is illustrated. The door opening system 40 is an electro-mechanical system including an actuator assembly, such as actuator 26 for example, connected at a first end 42 to a mounting bracket (not shown) on the moveable cowl door 24 and at a second end 44 to a mounting bracket (not shown) on the engine casing 22. The actuator assembly 26 is operable to translate the cowl door 24 connected thereto between a first, closed position, and a second, open position. The actuator assembly 26 is driven by an electric motor 46 operably coupled to a power supply 48. In an embodiment, a switch 50 is disposed between the electric motor 46 and the power supply 48 to selectively reverse the polarity of input to the electric motor 46 such that it can be run in clockwise as well as counter clockwise directions to extend or retract the actuator.

In addition the switch 50 can be used to terminate the supply of power to the motor 46 to stop the power input to the actuator assembly 26 at both ends of stroke thereof (fully retracted or fully extended positions of the actuator assembly 26) or at any intermediate stroke positions. In the illustrated, non-limiting embodiment, the switch 50 is a double pole double throw (DPDT) switch; however, any suitable switch 50 is within the scope of the disclosure. A flexible rotary shaft 52 connects the electric motor 46 to a corresponding drive input 54 of the actuator assembly 26. A gearbox 55, may, but need not be, arranged at the interface between the motor 46 and the flexible rotary shaft 52 to appropriately change the speed and torque transmitted from the motor 46 to the actuator assembly 26. Alternatively, the gearbox 55 can be integrated into the actuator assembly 26 as part of the drive input 54 and the electric motor 46 can be connected to the drive input 54 using a flexible rotary shaft.

In the illustrated non-limiting embodiment, the drive input 54 includes a torque limiter 56 for limiting the torque transmitted to the actuator assembly 26 and a coupling 58 for connecting to the flexible rotary shaft 52. Any suitable torque limiter such as a friction-plate type or ball-detent type may be used to limit the torque transmitted to the actuator assembly 26.

In another embodiment, the actuator assembly 26 may be manually operated by means of rotation of a lever or crank connected to the drive input 54. Accordingly, the power supply 48, switch 50, electric motor 46 and flexible shaft 52 may be eliminated. Such embodiments may be useful when the ground support equipment (electric motor and speed reduction gear box) is not available to operate the door opening system 40.

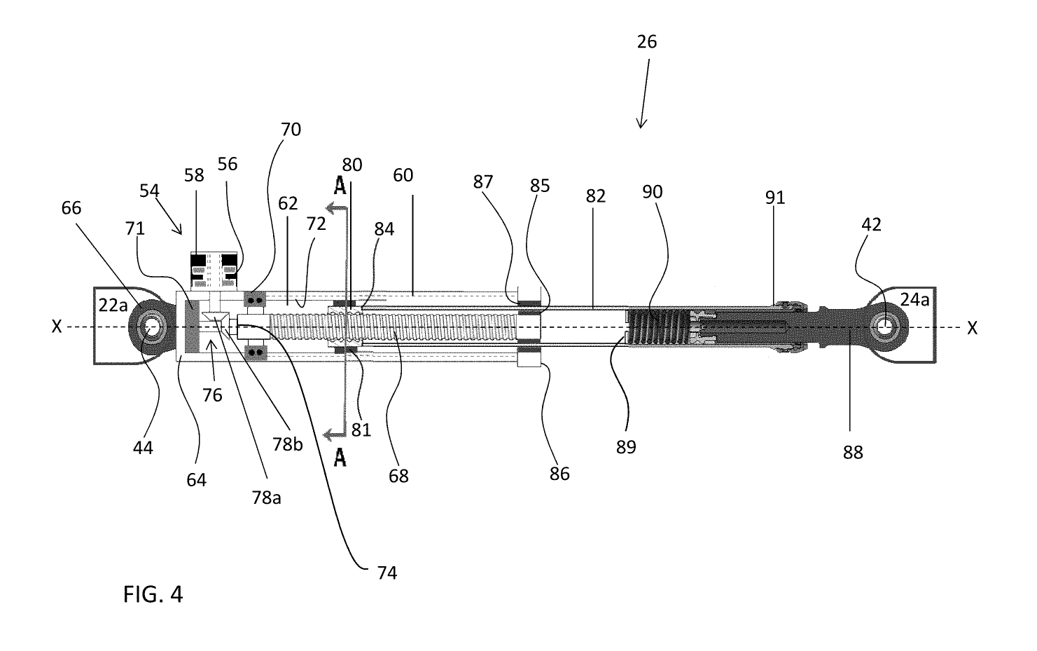

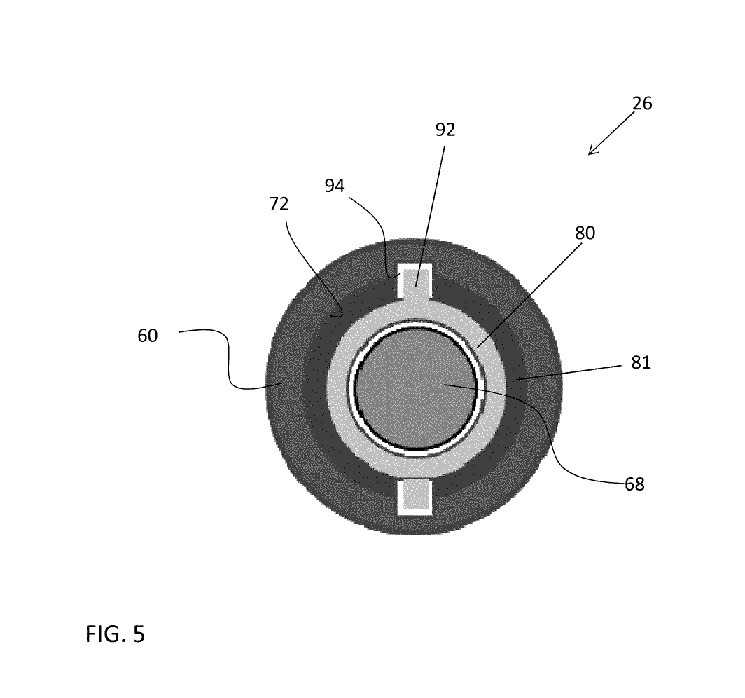

With specific reference now to FIGS. 4 and 5, the actuator assembly 26 includes a housing 60 having a substantially hollow interior 62. Arranged at the first end 64 of the housing 60 is a lug 66 configured to couple to a bracket 22a on the engine case 22. Mounted within the hollow interior 62 of the housing 60 is a screw shaft 68. The screw shaft 68 can be a lead screw shaft such as an ACME screw shaft for example, or it can be a ball screw shaft for higher efficiency. The screw shaft 68 may extend over only a portion of the length of the housing 60, or alternatively, over substantially the entire length of the housing 60. In the illustrated, non-limiting embodiment, the screw shaft 68 is supported at one end by one or more bearings 70 positioned between a portion of the shaft 68 and the interior surface 72 of the housing 60. At the other end, the screw shaft 68 is supported on bearing 85 which bears against a piston rod 82 which in turn is supported by bearing 87 attached to the housing 60.

The screw shaft 68 is configured to rotate about its longitudinal axis X relative to the housing 60. An end 74 of the screw shaft 68 is connected to the drive input 54 through a transmission 76 located generally adjacent a first end 64 of the housing 60. In the illustrated, non-limiting embodiment, the transmission 76 includes a plurality of bevel gears 78a & 78b. However, it should be understood that any suitable configuration of the transmission 76 is contemplated herein. The transmission 76 is configured to transmit power from the drive input 54 to the screw shaft 68 to rotate the screw shaft 68 about its longitudinal axis X in either a first, clockwise direction or a second, counter clockwise direction.

As shown, a nut 80 located within the hollow interior 62 of the housing 60 is engaged with the screw shaft 68. A generally hollow piston rod 82 is connected at a first end 84 to the nut 80 and extends through an opening formed in the second, opposite end 86 of the housing 60. A rod end 88 for connecting to a bracket 24a of the cowl door 24 is coupled to the second end 91 of the piston rod 82. In addition, in an embodiment, a lost motion device 90 is arranged between an inwardly extending flange 89 of the piston rod 82 and the rod end 88. The lost motion device 90 is configured to absorb mechanical vibration of the cowl door 24 and prevent transmission of such vibration to the engine casing 22. Additionally the lost motion device 90 provides a means to prevent generation of punch forces resulting from thermal expansion of the engine casing 22. Although the lost motion device 90 is illustrated as a resilient mechanism, such as a coil spring for example, any suitable lost motion device 90 is considered within the scope of the disclosure.

In operation, the torque is transmitted to the actuator assembly 26, such as from the electric motor 46 through the flex shaft 52 or manually, via the drive input 54. This torque causes a first gear 78a of the transmission 76 to rotate, which in turn causes a second gear 78b of the transmission 76 to rotate. Because the screw shaft 68 is operably coupled to the second gear 78b of the transmission 76, this rotation of the second gear 78b drives rotation of the screw shaft 68 about its longitudinal axis X.

A nut 80 is engaged with the screw shaft 68. The nut 80 can be a lead nut or a ball nut. In an embodiment, at least one key 92 extends outwardly from the nut 80 and is received within a corresponding key way 94 formed in the interior surface 72 of the housing 60. In the illustrated, non-limiting embodiment, engagement between the key 92 on the nut 80 and the key way 94 on the housing 60, restricts free rotation of the nut 80 and the piston rod 82 along with the screw shaft 68, during operation of the actuator assembly 26. As the rotation of the nut 80 is restrained by the key way slots 94, the nut 80 is forced to translate in the longitudinal direction of the screw shaft 68, when the screw shaft 68 rotates. A bearing 81 is interposed between the nut 80 and the housing inner surface 72 to reduce friction and wear as the nut 80 slides on the housing inner surface 72.

As the screw shaft 68 is rotated in a first direction, the nut 80 translates toward the second end 86 of the housing 60, causing the piston rod 82, and therefore the cowl door 24 coupled to the piston rod 82, to move from a first, closed position to a second, open position. Similarly, when the screw shaft 68 is rotated in a second, opposite direction, the nut 80 translates toward the first end 64 of the housing 60. As the nut 80 moves from the second end 86 toward the first end 64, the piston rod 82, and therefore the cowl door 24 coupled to the piston rod 82, move from a second, open position to a first, closed position. During operation of the actuator assembly 26, the torque limiter 56 is operable to limit the torque at both ends of the stroke of the piston rod 82 as the nut 80 comes in contact with the end stops 70 & 86. In addition, the torque limiter 56 protects the actuator assembly 26 in the event that a jam or stall condition arises therein.

When a lead screw shaft 68 along with a lead nut 80 are used, the thread helical angle of the lead screw shaft 68 can be designed to avoid back drive of the nut 80 under external loads. As a result, in an embodiment, the actuator assembly 26 can carry weight of the cowl door 24 and the corresponding wind loads acting thereon when the nut 80 is at any position. However, for higher helix angles and efficiencies, a one way no-back device 71 can be coupled to the lead screw shaft 68 near the first end 64 of the housing 60 to avoid back drive under external loads. Instead of the lead screw and lead nut, a ball screw and ball nut along with a no-back device 71 may be used to increase the efficiency further.

At the ends of the stroke of the piston rod 82, as the nut 80 comes in contact with the end stops 70 or 86, the torque spikes up and the torque limiter 56 slips, thus protecting the actuator assembly 26 from a high torque. After the torque limiter 56 slips, the electric motor 46 can be switched off using the switch 50. To retract the actuator assembly 26, the switch 50 is thrown in the reverse direction, thereby introducing a polarity change in the electric motor 46 and causing it to run in the opposite direction of rotation. This in turn drives the screw shaft 68 in a direction which causes the nut 80 and piston rod 82 to translate in the closing direction of the cowl door 24. A suitable shock absorber (not shown) may be incorporated to absorb the impact of the nut 80 with the end stops 70 and 86.

Because the actuator assembly 26 and the door opening system 40 are electromechanical, the hydraulic circuit and the complexities and problems associated therewith, such as susceptibility to oil leakage or oil contamination or performance loss at cold temperature, can be eliminated, thereby creating a more reliable system 40. A mechanical lock has also been eliminated from the system because the threaded engagement of the nut 80 and the lead screw shaft 68 along with a no-back device if required, will sustain the load transferred from cowl door 24. In addition, manual operation of the actuator assembly 26 is still possible even if the ground support power is unavailable. The system 40 disclosed herein does not rely on any electrical or electronic feedback from the actuator assembly 26 and hence is cost effective, simple and reliable as there is no necessity for using proximity sensors, limit switches or rotary variable differential transformer (RVDT) for sensing the end of stroke positions to switch off power.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for controlling the movement of an aircraft engine cowl door comprising:
an actuator assembly including:
a housing;
a screw shaft arranged at least partially within a hollow interior of the housing, the screw shaft being rotatable about an axis relative to the housing;
a transmission system coupled to the screw shaft to impart rotation to the screw shaft about the axis;
a nut engaged with the screw shaft; and
a piston rod having a rod end mounted thereto for connecting the nut to the cowl door of the engine, wherein the nut is translatable relative to the screw shaft to transition the cowl door between a first position and a second position.

2. The system of claim 1, wherein the nut includes a key and an interior surface of the housing includes a key way within which the key is received.

3. The system of claim 1, further comprising a first bracket mounted adjacent a first end of the housing and a second bracket mounted at an end of the piston rod, wherein the first bracket couples the actuator assembly to an engine casing and the second bracket couples the actuator assembly to the cowl door.

4. The system of claim 3, further comprising a lost motion device coupled to the piston rod, the lost motion device being operable to absorb mechanical vibration of the cowl door and thermal expansion of the engine casing.

5. The system of claim 1, wherein the transmission comprises a pair of bevel gears.

6. The system of claim 1, wherein the transmission couples the screw shaft to a drive input including a torque limiter, wherein the torque limiter is configured to slip at an end of a stroke of the piston rod.

7. The system of claim 1, further comprising a no-back device coupled to the screw shaft.

8. The system of claim 1, wherein the actuator assembly is manually powered.

9. The system of claim 8, further comprising a crank coupled to an input of the transmission.

10. The system of claim 1, wherein the actuator system is electrically powered.

11. The system of claim 10, further comprising an electric motor operably coupled to the actuator assembly via a flexible rotary shaft.

12. The system of claim 11, wherein the electric motor receives power from a power supply.

13. The system of claim 10, further comprising:
a speed reduction gear box coupled to the electric motor; and
a switch connected to an electrical power source which is capable of changing the polarity of the input to the electric motor such that the direction of rotation of the motor can be reversed.

14. The actuator assembly of claim 1, wherein movement of the cowl door between the first position and the second position provides access to the engine for maintenance.

15. A method of opening and closing the cowl doors of an aircraft engine comprising:
providing an actuator assembly configured to translate a movable cowl, the actuator system including a screw shaft, and a nut engaged with the screw shaft, and a transmission operably coupled to the screw shaft;
providing a torque to a drive input of the actuator assembly, the drive input being in communication with the transmission;
rotating the screw shaft in a first direction such that the nut coupled to the screw shaft moves relative to the screw shaft, thereby causing the movable cowl to translate from a first position to a second position.

16. The method of claim 15, further comprising rotating the screw shaft in a second, opposite direction such that the nut coupled to the screw shaft moves relative to the screw shaft, thereby causing the movable cowl door to translate from the second position to the first position.

17. The method of claim 15, wherein providing torque to the drive input includes transmitting torque from an electric motor to the drive input via a flexible rotary shaft.

18. The method of claim 15, wherein providing torque to the drive input includes manually supplying a torque to the drive input.

19. The method of claim 18, wherein manually supplying the torque includes rotating a crank.
